(19) United States
(12) Patent Application Publication
(10) Pub. No.: US 2018/0083317 A1
(43) Pub. Date: Mar. 22, 2018

(54) ADDITIVE COMPOSITION FOR LITHIUM BATTERY ELECTROLYTE, ORGANIC ELECTROLYTE INCLUDING THE SAME, AND LITHIUM BATTERY INCLUDING THE ADDITIVE COMPOSITION

(71) Applicant: SAMSUNG SDI CO., LTD., Yongin-si (KR)

(72) Inventors: Sejeong PARK, Yongin-si (KR); Hoseok YANG, Yongin-si (KR); Sujeong KOH, Yongin-si (KR); Yunhee KIM, Yongin-si (KR); Hyunwoo KIM, Yongin-si (KR); Minyoung LEE, Yongin-si (KR); Heeyeon HWANG, Yongin-si (KR)

(21) Appl. No.: 15/708,728

(22) Filed: Sep. 19, 2017

(30) Foreign Application Priority Data
Sep. 20, 2016 (KR) 10-2016-0120142

(51) Int. Cl. H01M 10/0567; H01M 10/0525; H01M 10/0568; H01M 10/0569

(52) U.S. Cl. CPC H01M 10/0567; H01M 10/0525; H01M 2300/0028; H01M 10/0569; H01M 10/0568

(57) ABSTRACT

Provided is an additive composition for a lithium battery electrolyte, the additive composition including a first compound represented by Formula 1 and a second compound represented by Formula 2:

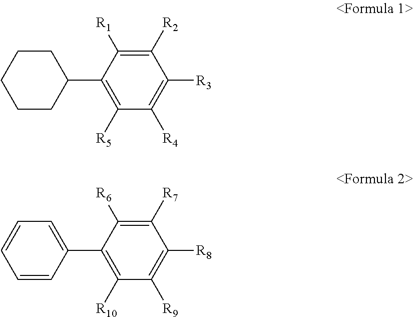

Also provided are an organic electrolyte including the additive composition, and a battery including the organic electrolyte.

### CROSS-REFERENCE TO RELATED APPLICATION

Korean Patent Application No. 10-2016-0120142, filed on Sep. 20, 2016, in the Korean Intellectual Property Office, and entitled: “Additive Composition for Lithium Battery Electrolyte, Organic Electrolyte Including the Same, and Lithium Battery Including the Additive Composition,” is incorporated by reference herein in its entirety.

### BACKGROUND

### 1. Field

Embodiments relate to an additive composition for a lithium battery electrolyte, an electrolyte including the same, and a lithium battery that including the electrolyte.

### 2. Description of the Related Art

Lithium batteries are used as a driving power source for portable electronic devices, such as video cameras, mobile phones, and laptops. Rechargeable lithium secondary batteries have an energy density per unit weight that is three times or higher than existing lead-acid batteries, nickel-cadmium batteries, nickel-hydrogen batteries, and nickel-zinc batteries, and are capable of high-speed charging.

### SUMMARY

Embodiments are directed to an additive composition for a lithium battery electrolyte, including a first compound represented by Formula 1 and a second compound represented by Formula 2:

<Formula 1>

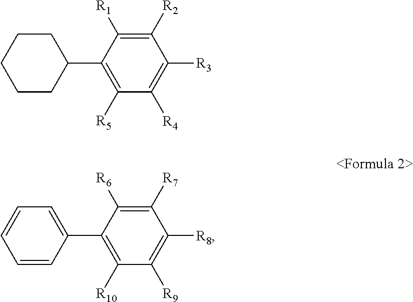

In Formulae 1 and 2,

R₁ to R₁₀ may each independently be hydrogen; a halogen atom; a C₁-C₅ alkyl group; a C₁-C₅ alkyl group substituted with a halogen atom; a C₂-C₅ alkenyl group; a C₂-C₅ alkenyl group substituted with a halogen atom; a C₂-C₅ alkynyl group; a C₂-C₅ alkynyl group substituted with a halogen atom; a C₄-C₁₀ cycloalkyl group; a C₄-C₁₀ cycloalkyl group substituted with a halogen atom; a C₅-C₁₀ aryl group; or a C₅-C₁₀ aryl group substituted with a halogen atom. At least one of R₁ to R₅ may be a halogen atom, and at least one of R₆ to R₁₀ may be a halogen atom.

A composition ratio of the first compound to the second compound may be in a range of about 1:2 to about 1:4 based on the total weight of the additive composition.

The composition ratio of the first compound to the second compound may be in a range of about 1:2 to about 1:3 based on the total weight of the additive composition.

R₁ to R₁₀ in Formulae 1 and 2 may each independently be hydrogen; a halogen atom; a methyl group; an ethyl group; a propyl group an isopropyl group; a butyl group; an isobutyl group; a tert-butyl group; or a pentyl group.

At least one of R₁ to R₅ in Formula 1 may be fluorine, and at least one of R₆ to R₁₀ in Formula 2 may be fluorine.

The first compound may include one or more of 1-fluoro-2-cyclohexylbenzene, 1-fluoro-3-cyclohexylbenzene, or 1-fluoro-4-cyclohexylbenzene, and the second compound may include one or more of 1-fluoro-2-phenylbenzene, 1-fluoro-3-phenylbenzene, or 1-fluoro-4-phenylbenzene.

The first compound and the second compound in the additive composition may decompose at a voltage in a range of about 4.7 V to about 4.8 V.

Embodiments are also directed to an organic electrolyte including a lithium salt; an organic solvent; and the additive composition according to an embodiment.

An amount of the additive composition may be in a range of about 2.5 wt % to about 4 wt % based on the total weight of the organic electrolyte.

An amount of the first compound may be in a range of about 0.5 wt % to about 2 wt % based on the total weight of the organic electrolyte.

An amount of the second compound may be in a range of about 2 wt % to about 3.5 wt % based on the total weight of the organic electrolyte.

A composition ratio of the first compound to the second compound in the additive composition may be in a range of about 1:2 to about 1:4 based on the total weight of the additive composition, and an amount of the additive composition may be in a range of about 2.5 wt % to about 4 wt % based on the total weight of the organic electrolyte.

The lithium salt may include one or more of LiPF₆, LiBF₄, LiSbF₆, LiAsF₆, LiClO₄, LiCF₃SO₃, Li(CF₃SO₂)₂N, LiC₄F₉SO₃, LiAlO₂, LiAlCl₄, LiN(CₓF₂ₓ₊₁SO₂)(C_{y}F_{2y+1}SO₂)(2≦x≦20, 2≦y≦20), LiCl, or LiI.

A concentration of the lithium salt in the electrolyte may be in a range of about 0.01 M to about 2.0 M.

The organic solvent may include one or more of a diallylcarbonate, a cyclic carbonate, a linear or cyclic ester, a linear or cyclic amide, an aliphatic nitrile, or a linear or cyclic ether, or a derivative thereof.

Embodiments are also directed to a lithium battery including a positive electrode; a negative electrode; and the organic electrolyte.

The lithium battery may have a voltage of at least 3.8 V.

### BRIEF DESCRIPTION OF THE DRAWINGS

Features will become apparent to those of ordinary skill in the art by describing in detail exemplary embodiments with reference to the attached drawings in which:

FIG. 1 illustrates a schematic diagram of a lithium battery according to an embodiment;

FIG. 2 illustrates a graph showing changes in time-dependent voltage/current (i.e., resistance) of lithium batteries prepared according to Examples 5 to 7 and Comparative Examples 8 to 10, wherein the lithium batteries are overcharged at the condition of 1 C, 18.5 V, and thermal cut-off at 82° C.;

FIG. 3 illustrates a graph showing changes in time-dependent voltage/current (i.e., resistance) of lithium batteries prepared according to Example 8 and Comparative Example 14, wherein the lithium batteries are overcharged at the condition of 1 C, 18.5 V, and thermal cut-off at 82° C.;

FIG. 4 illustrates a graph showing results of evaluating high-temperature charge/discharge characteristics of lithium batteries prepared according to Examples 5 to 7 and Comparative Examples 11 to 13; and

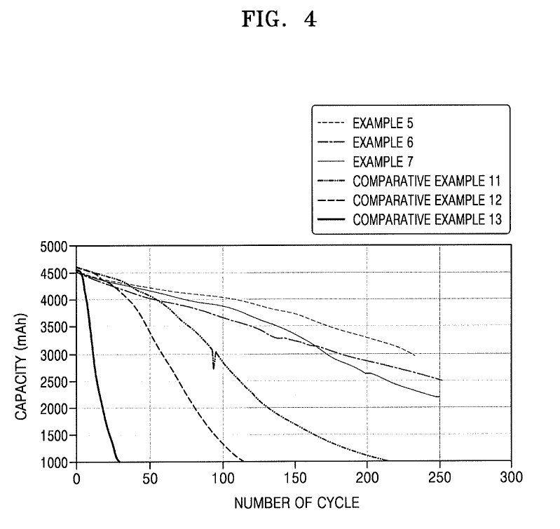

FIG. 5 illustrates a graph showing results obtained by performing linear sweep voltammetry (LSV) on electrolytes each containing cyclohexylbenzene (CHB), fluorocyclohexylbenzene (FCHB), and fluorobiphenyl (FBP).

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art. In the drawing figures, the dimensions of layers and regions may be exaggerated for clarity of illustration. Like reference numerals refer to like elements throughout.

As used herein, the term “and/or” includes any and all combinations of one or more of the associated listed items. Expressions such as “at least one of,” when preceding a list of elements, modify the entire list of elements and do not modify the individual elements of the list.

Hereinafter, an additive composition for a lithium battery electrolyte, an organic electrolyte including the additive composition, and a lithium battery including the organic electrolyte will be described in detail with reference to example embodiments

According to an example embodiment, an additive composition for a lithium battery electrolyte may include a first compound represented by Formula 1 and a second compound represented by Formula 2:

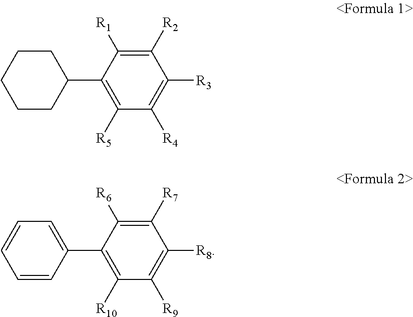

In Formulae 1 and 2,

R₁ to R₁₀ may each independently be hydrogen; a halogen atom; a C₁-C₅ alkyl group; a C₁-C₅ alkyl group substituted with a halogen atom; a C₂-C₅ alkenyl group; a C₂-C₅ alkenyl group substituted with a halogen atom; a C₂-C₅ alkynyl group; a C₂-C₅ alkynyl group substituted with a halogen atom; a C₄-C₁₀ cycloalkyl group; a C₄-C₁₀ cycloalkyl group substituted with a halogen atom; a C₅-C₁₀ aryl group; or a C₅-C₁₀ aryl group substituted with a halogen atom. In an implementation, at least one selected from R₁ to R₅ is a halogen atom, and at least one selected from R₆ to R₁₀ is a halogen atom.

The composition ratio of the first compound to the second compound may be within a suitable range where stability of a battery is secured by cutting off current flow in a battery, and at the same time, high-temperature lifespan characteristics of a battery are not deteriorated.

For example, a composition ratio of the first compound to the second compound may be in a range of about 1:2 to about 1:4 based on the total weight of the additive composition, but the embodiments are not limited thereto. For example, the composition ratio of the first compound to the second compound may be in a range of about 1:2 to about 1:3 based on the total weight of the additive composition. For example, the composition ratio of the first compound to the second compound may be in a range of about 1:2 to about 1:2.5 based on the total weight of the additive composition.

Within these ranges above, the stability against overcharging of a high-voltage battery and battery performance including high-temperature lifespan characteristics may be obtained.

In Formulae 1 and 2, R₁ to R₁₀ may each independently be selected from: hydrogen; a halogen atom; a methyl group; an ethyl group; a propyl group an isopropyl group; a butyl group; an isobutyl group; a tert-butyl group; and a pentyl group, but the embodiments are not limited thereto.

For example, in Formulae 1 and 2, R₁ to R₁₀ may each independently be selected from hydrogen or a halogen atom. For example, in Formulae 1 and 2, R₁ to R₁₀ may each independently hydrogen or fluorine (F).

At least one selected from R₁ to R₅ in Formula 1 may be F, and at least one selected from R₆ to R₁₀ in Formula 2 may be F.

The additive composition may include the first compound selected from a 1-fluoro-2-cyclohexylbenzene group, a 1-fluoro-3-cyclohexylbenzene group, and a 1-fluoro-4-cyclohexylbenzene group, and the second compound selected from a 1-fluoro-2-phenylbenzene group, a 1-fluoro-3-phenylbenzene group, and a 1-fluoro-4-phenylbenzene group.

For example, the additive composition may include 1-fluoro-4-cyclohexylbenzene and 1-fluoro-2-biphenyl.

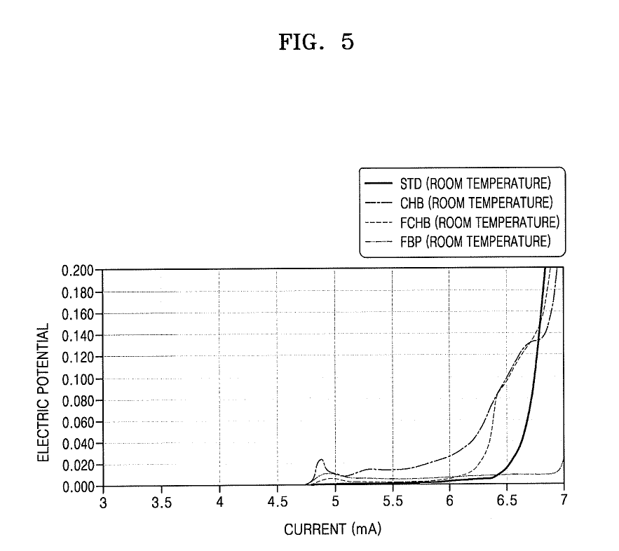

The first compound and the second compound included in the additive composition may both decompose at a voltage in a range of about 4.7 V to about 4.8 V. In other words, referring to FIG. 5, the first compound and the second compound may both have an oxidation decomposition potential in a range of about 4.7 V to about 4.8 V.

Therefore, when the additive composition is subjected to an overvoltage (for example, 4.7 V) higher than a certain voltage by continuous charging of a battery, the current may be cut off by an electrochemical reaction. For example, without being bound by theory it is believed that, when a battery is subjected to an overvoltage, i.e., about 4.7 V, that is higher than the oxidation decomposition potential of the additive composition, the additive composition forms a film on a surface of a positive electrode through an oxidation exothermic reaction and increases an internal resistance by suppressing the movement of lithium ions. However, such an increase in the internal resistance causes an increase in an internal temperature of a battery, and accordingly, pores in a separation film are blocked, thereby enabling thermal cut-off of a battery. Therefore, the stability of a battery against overcharging may be secured. In this regard, the additive composition may function as an overcharge suppressor.

According to another example embodiment, an organic electrolyte may include a lithium salt; an organic solvent; and the additive composition including the first compound and the second compound.

As described above, the additive composition may function as an overcharge suppressor.

A case where the first compound and the second compound are used in combination may be more advantageous than a case where either the first compound or the second compound is used alone in the additive composition, in terms of an overcharge suppressor. Without being bound by theory it is believed that, when the first compound or the second compound is used alone, heat generated by an oxidation exothermic reaction during overcharging is not sufficient to induce thermal cut-off of a battery. However, when the first compound and the second compound are used in combination, the first compound and the second compound start to decompose at the same time, and accordingly, synergy effect is obtained therebetween. Accordingly, it is considered that heat that is sufficient to induce thermal cut-off of a battery is generated.

In this regard, considering the synergy effect with the second compound, an amount of the first compound in the additive composition may be at least about 0.5 wt % based on the total weight of the organic electrolyte. However, embodiments are not limited thereto, and an appropriate amount of the first compound may be used so as to satisfy the composition ratio described above.

In addition, considering the synergy effect with the first compound, an amount of the second compound in the additive composition may be at least about 2 wt % based on the total weight of the organic electrolyte. However, embodiments are not limited thereto, and an appropriate amount of the second compound may be used so as to satisfy the composition ratio described above.

In addition, an amount of the additive composition including the first compound and the second compound may be at least about 2.5 wt % in the organic electrolyte based on the total weight of the organic electrolyte. Within this range, an oxidation exothermic reaction sufficient to induce sufficient thermal cut-off may be generated. In addition, as the amount of the additive composition increases, the time required for the thermal cut-off from the oxidation exothermic reaction may be shortened. Thus, when the amount of the additive composition is about 2.5 wt % or more, the additive composition may function as an overcharge suppressor.

If the amount of the additive composition in the organic electrolyte is excessively high, expansion of a battery may occur due to excessive gas, and accordingly, lifespan characteristics of a battery may be degraded.

In this regard, the amount of the additive composition may be in a range of about 2.5 wt % to about 4 wt % based on the total weight of the organic electrolyte. However, the amount may be within any suitable range where the additive composition functions as an overcharge suppressor and lifespan characteristics thereof are not deteriorated.

For example, the amount of the additive composition may be in a range of about 2.5 wt % to about 3.5 wt % based on the total weight of the organic electrolyte. For example, the amount of the additive composition may be in a range of about 2.5 wt % to about 3.0 wt % based on the total weight of the organic electrolyte. For example, the amount of the additive composition may be in a range of about 2.5 wt % to about 3.0 wt % to about 3.5 wt % based on the total weight of the organic electrolyte.

The amount of the first compound may be in a range of about 0.5 wt % to about 2.0 wt % based on the total weight of the organic electrolyte, but the embodiments are not limited thereto. For example, the amount of the first compound may be in a range of about 0.5 wt % to about 1.5 wt % based on the total weight of the organic electrolyte. For example, the amount of the first compound may be in a range of about 0.5 wt % to about 1.0 wt % based on the total weight of the organic electrolyte.

The amount of the second compound may be in a range of about 2.0 wt % to about 3.5 wt % based on the total weight of the organic electrolyte, but the embodiments are not limited thereto. For example, the amount of the second compound may be in a range of about 2.0 wt % to about 3.0 wt % based on the total weight of the organic electrolyte. For example, the amount of the second compound may be in a range of about 2.0 wt % to about 2.5 wt % based on the total weight of the organic electrolyte.

The composition ratio of the first compound to the second compound in the additive composition may be in a range of about 1:2 to about 1:4 based on the total weight of the additive composition, wherein the amount of the additive composition may be in a range of about 1.5 wt % to about 4 wt % based on the total weight of the organic electrolyte, but the embodiments are not limited thereto. The composition ratio may be within any suitable range where the additive composition maintains a function thereof as an overcharge suppressor and exhibits excellent high-temperature lifespan characteristics of a battery.

The organic electrolyte may include an organic solvent. The organic solvent may include, for example, one or more of a diallylcarbonate, a cyclic carbonate, a linear or cyclic ester, a linear or cyclic amide, an aliphatic nitrile, or a linear or cyclic ether, or a derivative thereof.

For example, the organic solvent may be or include one or more of dimethyl carbonate (DMC), ethylmethyl carbonate (EMC), methylpropyl carbonate, ethylpropyl carbonate, diethyl carbonate (DEC), dipropyl carbonate, propylene carbonate (PC), ethylene carbonate (EC), fluoroethylene carbonate (FEC), butylene carbonate, ethylpropionate (EP), ethyl butyrate, acetonitrile (AN), succinonitrile (SN), dimethylsulfoxide, dimethylformamide, dimethylacetamide, gamma-valerolactone, gamma-butyrolactone, or tetrahydrofuran. However, the embodiments are not limited thereto, and any solvent suitable as the organic solvent in the organic electrolyte in the art may be used.

In some embodiments, for the purpose of improving lifespan characteristics of a battery, suppressing a decrease of a battery capacity, and improving a discharge capacity of a battery, the organic electrolyte may include at least one selected from propane sulfone (PS), vinylene carbonate (VC), and vinylene ethylene carbonate (VEC). However, the embodiments are not limited thereto, and any material that may be dissolved in the organic electrolyte in the art may be used.

In the organic electrolyte, a concentration of the lithium salt may be in a range of about 0.01 M to about 2.0 M. However, the embodiments are not limited thereto, and the lithium salt may be used in an appropriate concentration. When the concentration of the lithium salt is within this range above, a battery may have improved battery characteristics.

The lithium salt used in the organic electrolyte is not particularly limited, and any material suitable as the lithium salt in the art may be used. For example, LiPF₆, LiBF₄, LiSbF₆, LiAsF₆, LiClO₄, LiCF₃SO₃, Li(CF₃SO₂)₂N, LiC₄F₉SO₃, LiAlO₂, LiAlCl₄, LiN(CₓF₂ₓ₊₁SO₂)(C_{y}F_{2y+1}SO₂)(2≦x≦20, 25≦y≦20), LiCl, LiI, or a mixture thereof may be used.

The organic electrolyte may be liquid or gel. The organic electrolyte may be prepared by adding the lithium salt and an additive to the organic solvent.

Regarding the term “Cₐ to C_{b}” used herein, a and b each indicate the number of a carbon atom of a particular functional group. That is, the functional group may include carbon atoms in the number of a to b. For example, “a C₁ to C₄ alkyl group” indicates an alkyl group having 1 to 4 carbon atoms, and in this regard, examples thereof include CH₃—, CH₃CH₂—, CH₃CH₂CH₂—, (CH₃)₂CH—, CH₃CH₂CH₂CH₂—, CH₃CH₂CH(CH₃)—, and (CH₃)₃C—.

The term “alkyl group” used herein refers to a branched or non-branched aliphatic hydrocarbon group. In an embodiment, the alkyl group may be or may not be substituted. Examples of the alkyl group include a methyl group, an ethyl group, a propyl group, an isopropyl group, a butyl group, an iso-butyl group, a tert-butyl group, a pentyl group, a hexyl group, a cyclopropyl group, a cyclopentyl group, a cyclohexyl group, and a cycloheptyl group, but the embodiments are not limited thereto. Each of the examples may be or may not be, optionally, substituted. In an embodiment, the alkyl group may include 1 to 5 carbon atoms, and examples thereof include a methyl group, an ethyl group, a propyl group, an isopropyl group, a butyl group, an iso-butyl group, a sec-butyl group, a tert-butyl group, a pentyl group, and a 3-pentyl group, but the embodiments are not limited thereto.

The term “cycloalkyl group” used herein refers to a fully saturated carbocyclic ring or ring system, and examples thereof include a cyclopropyl group, a cyclobutyl group, a cyclopentyl group, and a cyclohexyl group.

The term “alkenyl group” used herein refers to a hydrocarbon group including at least one carbon-carbon double bond and 2 to 5 carbon atoms, and examples thereof include an ethenyl group, an 1-propenyl group, a 2-propenyl group, a 2-methyl-1-propenyl group, a propenyl group, an 1-butenyl group, a 2-butenyl group, a cyclopropenyl group, and a cyclopentenyl group. However, the embodiments are not limited thereto. In an embodiment, the alkenyl group may be or may not be substituted. In some embodiments, the alkenyl group may include 2 to 5 carbon atoms.

The term “alkynyl group” used herein refers to a hydrocarbon group including at least one carbon-carbon triple bond and 2 to 5 carbon atoms, and examples thereof include an ethenyl group, an 1-propynyl group, an 1-butynyl group, and a 2-butynyl group. However, the embodiments are not limited thereto. In an embodiment, the alkynyl group may be or may not be substituted. In some embodiments, the alkynyl group may include 2 to 5 carbon atoms.

The term “aryl group” used herein refers to an aromatic ring or ring system of which a ring skeleton consists of carbon atoms only (i.e., a fused ring in which two adjacent carbon atoms are shared). When the aryl group is a ring system, each ring in the ring system is an aromatic ring. Examples of the aryl group include a phenyl group, a biphenyl group, a naphthyl group, a phenanthrenyl group, and a naphthacenyl group, but the embodiments are not limited thereto. The aryl group may be or may not be substituted.

The term “halogen atom” used herein refers to a stable Group XVII element of the Periodic Table of the Elements, and examples thereof include fluorine, chlorine, bromine, and iodine. In an embodiment, the halogen atom may be fluorine and/or chlorine.

According to another embodiment, a lithium battery may include a positive electrode, a negative electrode, and the organic electrolyte. The lithium battery is not particularly limited in structure, and may be a lithium secondary battery, such as a lithium ion battery, a lithium ion polymer batter, a lithium sulfur battery, and a lithium air battery as well as a lithium primary battery.

For example, the lithium battery may be manufactured in the following manner.

First, a positive electrode is prepared.

For example, a positive active material, a conducting agent, a binder, and a solvent are mixed to prepare a positive active material composition. In an embodiment, the positive active material composition may be directly coated on a metallic current collector to prepare a positive electrode plate. In some embodiments, the positive active material composition may be cast on a separate support to form a positive active material film, which may then be separated from the support and laminated on a metallic current collector to prepare a positive electrode plate. The positive electrode is not limited to the examples described above, and may be one of a variety of types.

The positive active material may be any one available in the art, and for example, may be a lithium-containing metal oxide. In an embodiment, the positive active material may be at least one of a composite oxide of lithium with a metal selected from cobalt (Co), manganese (Mn), nickel (Ni), and combinations thereof. In some embodiments, the positive active material may be a compound represented by one of the following formulae:

LiₐA_{1-b}B_{b}D₂ (where 0.90≦a≦1.8 and 0≦b≦0.5); LiₐE_{1-b}B_{b}O_{2-c}D_{c} (where 0.90<a<1.8, 0≦b≦0.5, and 0≦c≦0.05): LiE_{2-b}B_{b}O_{4-c}D_{c} (where 0≦b≦0.5 and 0≦c≦0.05); LiₐNi_{1-b-c}CoₕB_{c}D_{α} (where 0.90≦a≦1.8, 0≦b≦0.5, 0≦c≦0.05, and 0≦α≦2); LiₐN_{1-b-c}Co_{b}B_{c}O_{2-α}F_{α} (where 0.90≦a≦1.8, 0≦b≦0.5, 0≦c≦0.05, and 0≦α≦2); LiₐNi_{1-b-c}CO_{b}B_{c}O_{2-α}F₂ (where 0.90≦a≦1.8, 0≦b≦0.5, 0≦c≦0.05, and 0≦α≦2); LiₐNi_{1-b-c}Mn_{b}B_{c}D_{α} (where 0.90≦a≦1.8, 0≦b≦0.5, 0≦c≦0.05, and 0≦α≦2); LiₐNi_{1-b-c}Mn_{b}B_{c}O_{2-α}F_{α} (where 0.90≦a≦1.8, 0≦b≦0.5, 0≦c≦0.05, and 0≦α≦2); LiₐNi_{1-b-c}Mn_{b}B_{c}O_{2-α}F₂ (where 0.90≦a≦1.8, 0≦b≦0.5, 0≦c≦0.05, and 0≦α≦2); LiₐNi_{b}E_{c}G_{d}O₂ (where 0.90≦a≦1.8, 0≦b≦0.9, 0≦c≦0.5, and 0.001≦d≦0.1); LiₐNi_{b}Co_{c}Mn_{d}GeO₂ (where 0.90≦a≦1.8, 0≦b≦0.9, 0≦c≦0.5, 0≦d≦0.5, and 0.001≦e≦0.1.); LiₐNiG_{b}O₂ (where 0.90≦a≦1.8 and 0.001≦b≦0.1); LiₐCoG_{b}O₂ (where 0.90≦a≦1.8 and 0.001≦b≦0.1.); LiₐMnG_{b}O₂ (where 0.90≦a≦1.8 and 0.001≦b≦0.1.); LiₐMn₂G_{b}O₄ (where 0.90≦a≦1.8 and 0.001≦b≦0.1); QO₂; QS₂; LiQS₂; V₂O₅; LiV₂O₅; LiIO₂; LiNiVO₄; Li_{(3-f)}J₂(PO₄)₃ (where 0≦f≦2); Li_{(3-f)}Fe₂(PO₄)₃(where 0≦f≦2); and LiFePO₄.

In the formulae above, A may be selected from nickel (Ni), cobalt (Co), manganese (Mn), and combinations thereof; B may be selected from aluminum (Al), nickel (Ni), cobalt (Co), manganese (Mn), chromium (Cr), iron (Fe), magnesium (Mg), strontium (Sr), vanadium (V), a rare earth element, and combinations thereof; D may be selected from oxygen (O), fluorine (F), sulfur (S), phosphorus (P), and combinations thereof; E may be selected from cobalt (Co), manganese (Mn), and combinations thereof; F may be selected from fluorine (F), sulfur (S), phosphorus (P), and combinations thereof; G may be selected from aluminum (Al), chromium (Cr), manganese (Mn), iron (Fe), magnesium (Mg), lanthanum (La), cerium (Ce), strontium (Sr), vanadium (V), and combinations thereof; Q may be selected from titanium (Ti), molybdenum (Mo), manganese (Mn), and combinations thereof; I may be selected from chromium (Cr), vanadium (V), iron (Fe), scandium (Sc), yttrium (Y), and combinations thereof; and J may be selected from vanadium (V), chromium (Cr), manganese (Mn), cobalt (Co), nickel (Ni), copper (Cu), and combinations thereof.

In some embodiments, the positive active material may be LiCoO₂, LiMnₓO₂ₓ (where x=1, 2), LiNi₁₋ₓMnₓO₂ₓ (where 0<x<1), LiNi_{1-x-y}CoₓMn_{y}O₂ (where 0<x<0.5 and 0≦y≦0.5), or LiFePO₄.

The compounds listed above as positive active materials may have a surface coating layer. In an embodiment, a mixture of a compound without a coating layer and a compound having a coating layer, the compounds being selected from the compounds listed above, may be used. In some embodiments, the coating layer may include at least one compound of a coating element selected from oxide, hydroxide, oxyhydroxide, oxycarbonate, and hydroxycarbonate of the coating element. In some embodiments, the compounds for the coating layer may be amorphous or crystalline. In some embodiments, the coating element for the coating layer may be magnesium (Mg), aluminum (Al), cobalt (Co), potassium (K), sodium (Na), calcium (Ca), silicon (Si), titanium (Ti), vanadium (V), tin (Sn), germanium (Ge), gallium (Ga), boron (B), arsenic (As), zirconium (Zr), or a combination thereof. In some embodiments, the coating layer may be formed using any method (for example, a spray coating method or dipping method) that does not adversely affect the physical properties of the positive active material when a compound of the coating element is used. The coating methods may be well understood by one of ordinary skill in the art, and thus a detailed description thereof will be omitted.

The conducting agent may be carbon black or graphite particulates, but the embodiments are not limited thereto. Any material available as the conducting agent in the related art may be used.

Examples of the binder include a vinylidene fluoride/hexafluoropropylene copolymer, polyvinylidene fluoride (PVDF), polyacrylonitrile, polymethylmethacrylate, polytetrafluoroethylene, mixtures thereof, and a styrene butadiene rubber polymer, but the embodiments are not limited thereto. Any material available as a binding agent in the art may be used.

Examples of the solvent include N-methyl-pyrrolidone, acetone, and water, but the embodiments are not limited thereto. Any material available as a solvent in the art may be used.

The amounts of the positive active material, the conducting agent, the binder, and the solvent may be in ranges that are commonly used in lithium batteries. At least one of the conducting agent, the binder, and the solvent may be omitted according to the use and the structure of the lithium battery.

Next, a negative electrode is prepared.

For example, a negative active material, a conducting agent, a binder, and a solvent are mixed to prepare a negative active material composition. In an embodiment, the negative active material composition may be directly coated on a metallic current collector and dried to prepare a negative electrode plate. In some embodiments, the negative active material composition may be cast on a separate support to form a negative active material film, which may then be separated from the support and laminated on a metallic current collector to prepare a negative electrode plate.

The negative active material may be any negative active material for a lithium battery available in the art. For example, the negative active material may include at least one selected from lithium metal, a metal that is alloyable with lithium, a transition metal oxide, a non-transition metal oxide, and a carbonaceous material.

Examples of the metal alloyable with lithium include Si, Sn, Al, Ge, Pb, Bi, Sb a Si—Y alloy (where Y is an alkali metal, an alkali earth metal, a Group XIII element, a Group XIV element, a transition metal, a rare earth element, or a combination thereof, and Y is not, and Y is not Si), a Sn—Y alloy (where Y is an alkali metal, an alkali earth metal, a Group XIII element, a Group XIV element, a transition metal, a rare earth element, or a combination thereof, and Y is not Sn). In some embodiments, Y may be magnesium (Mg), calcium (Ca), strontium (Sr), barium (Ba), radium (Ra), scandium (Sc), yttrium (Y), titanium (Ti), zirconium (Zr), hafnium (Hf), rutherfordium (Rf), vanadium (V), niobium (Nb), tantalum (Ta), dubnium (Db), chromium (Cr), molybdenum (Mo), tungsten (W), seaborgium (Sg), technetium (Tc), rhenium (Re), bohrium (Bh), iron (Fe), lead (Pb), ruthenium (Ru), osmium (Os), hassium (Hs), rhodium (Rh), iridium (Ir), palladium (Pd), platinum (Pt), copper (Cu), silver (Ag), gold (Au), zinc (Zn), cadmium (Cd), boron (B), aluminum (Al), gallium (Ga), tin (Sn), indium (In), titanium (Ti), germanium (Ge), phosphorus (P), arsenic (As), antimony (Sb), bismuth (Bi), sulfur (S), selenium (Se), tellurium (Te), polonium (Po), or combinations thereof.

Examples of the transition metal oxide include a lithium titanium oxide, a vanadium oxide, and a lithium vanadium oxide.

Examples of the non-transition metal oxide include SnO₂ and SiOₓ (where 0<x<2).

Examples of the carbonaceous material include crystalline carbon, amorphous carbon, or a combination thereof. Examples of the crystalline carbon include graphite, such as natural graphite or artificial graphite that are in shapeless, plate, flake, spherical, or fibrous form. Examples of the amorphous carbon include soft carbon (carbon sintered at low temperatures), hard carbon, meso-phase pitch carbides, and sintered cokes.

The conducting agent, the binder, and the solvent used for the negative active material composition may be the same as those used for the positive active material composition.

The amounts of the negative active material, the conducting agent, the binder, and the solvent may be the same levels generally used in the art for lithium batteries. At least one of the conducting agent, the binder, and the solvent may be omitted according to the use and the structure of the lithium battery.

Next, a separator to be disposed between the positive electrode and the negative electrode is prepared.

The separator for the lithium battery may be any suitable separator that is commonly used in lithium batteries. In an embodiment, the separator may have low resistance to migration of ions in an electrolyte and have an excellent electrolyte-retaining ability. Examples of the separator include glass fiber, polyester, Teflon, polyethylene, polypropylene, polytetrafluoroethylene (PTFE), and a combination thereof, each of which may be a non-woven or woven fabric. For example, a rollable separator including polyethylene or polypropylene may be used for a lithium ion battery. A separator with a good organic electrolyte-retaining ability may be used for a lithium ion polymer battery. For example, the separator may be manufactured in the following manner.

A polymer resin, a filler, and a solvent may be mixed together to prepare a separator composition. Then, the separator composition may be directly coated on an electrode, and then dried to form the separator. In some embodiments, the separator composition may be cast on a support and then dried to form a separator film, which may then be separated from the support and laminated on an electrode to form the separator.

The polymer resin used to manufacture the separator may be any material that is commonly used as a binder for electrode plates. Examples of the polymer resin include a vinylidenefluoride/hexafluoropropylene copolymer, polyvinylidene fluoride (PVDF), polyacrylonitrile, polymethylmethacrylate, and a mixture thereof.

Then, the organic electrolyte is prepared.

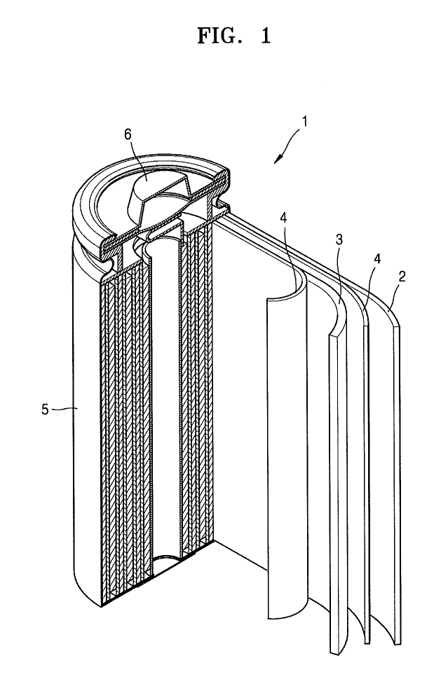

As shown in FIG. 1, a lithium battery 1 includes a positive electrode 3, a negative electrode 2, and a separator 4. The positive electrode 3, the negative electrode 2, and the separator 4 may be wound or folded, and then sealed in a battery case 5. Then, the battery case 5 may be filled with an organic electrolyte and sealed with a cap assembly 6, thereby completing the manufacture of the lithium battery 1. The battery case 5 may be a cylindrical type, a rectangular type, or a thin-film type. For example, the lithium battery 1 may be a large-sized thin-film battery or a lithium ion battery.

The separator 4 may be disposed between the positive electrode 3 and the negative electrode 2 to form a battery assembly. The battery assembly may be stacked in a bi-cell structure and impregnated with the organic electrolyte. In an embodiment, the resultant assembly may be put into a pouch and hermetically sealed, thereby completing the manufacture of a lithium ion polymer battery.

In addition, a plurality of battery assemblies may be stacked to form a battery pack, which may be used in any device that requires high capacity and high output, for example, in a laptop computer, a smart phone, or an electric vehicle.

In addition, the lithium battery 1 may have improved lifespan characteristics and high rate characteristics, and thus may be used in an electric vehicle (EV), for example, in a hybrid vehicle such as a plug-in hybrid electric vehicle (PHEV). The lithium battery 1 may be applicable to the high-power storage field. For example, the lithium battery 1 may be used in an electric bicycle or a power tool.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

(Preparation of Organic Electrolyte)

### Example 1: Fluorocyclohexylbenzene (FCHB) 0.5 wt %+FBP 2 wt %

An organic electrolyte was prepared by adding 0.5 wt % of 1-fluoro-4-cyclohexylbenzene and 2 wt % of 1-fluoro-2-phenylbenzene, which are additives, to a mixture obtained by using 1.3 M LiPF₆, 0.2 wt % of LiBF₄, 6 wt % of FEC, 3 wt % of SN, 2.5 wt % of PS, 1 wt % of VEC, 0.5 wt % of VC, and 2 wt % of AN as lithium salts and adding them to a mixed solution of EC/EP/DEC/PC (weight ratio: EC/EP/DEC/PC=(10)/(20)/(50)/(20).

### Example 2: FCHB 1 wt %+FBP 2 wt %

An organic electrolyte was prepared in the same manner as in Example 1, except that 1 wt % of 1-fluoro-4-cyclohexylbenzene and 2 wt % of 1-fluoro-2-phenylbenzene were added instead of the additives of Example 1.

### Example 3: FCHB 2 wt %+FBP 2 wt %

An organic electrolyte was prepared in the same manner as in Example 1, except that 2 wt % of 1-fluoro-4-cyclohexylbenzene and 2 wt % of 1-fluoro-2-phenylbenzene 2 wt % were added instead of the additives of Example 1.

### Example 4: FCHB 0.5 wt %+FBP 3 wt %

An organic electrolyte was prepared in the same manner as in Example 1, except that 0.5 wt % of 1-fluoro-4-cyclohexylbenzene and 3 wt % of 1-fluoro-2-phenylbenzene were added instead of the additives of Example 1.

### Comparative Example 1: FBP 2 wt %

An organic electrolyte was prepared by adding 2 wt % of 1-fluoro-2-biphenyl, which is an additive, to a mixture obtained by using 1.3 M LiPF₆, 0.2 wt % of LiBF₄, 6 wt % of FEC, 3 wt % of SN, 2.5 wt % of PS, 1 wt % of VEC, 0.5 wt % of VC, and 2 wt % of AN as lithium salts and adding them to a mixed solution of EC/EP/DEC/PC (weight ratio: EC/EP/DEC/PC=(10)/(20)/(50)/(20)).

### Comparative Example 2: FCHB 2 wt %

An organic electrolyte was prepared in the same manner as in Comparative Example 1, except that 2 wt % of 1-fluoro-4-cyclohexylbenzene was used instead of the additive of Comparative Example 1.

### Comparative Example 3: FCHB 1 wt %+FBP 1 wt %

An organic electrolyte was prepared in the same manner as in Comparative Example 1, except that 1 wt % of 1-fluoro-4-cyclohexylbenzene and 1 wt % of 1-fluoro-2-phenylbenzene were used instead of the additive of Comparative Example 1.

### Comparative Example 4: FCHB 1 wt %+FBP 4 wt %

An organic electrolyte was prepared in the same manner as in Comparative Example 1, except that 1 wt % of 1-fluoro-4-cyclohexylbenzene and 4 wt % of 1-fluoro-2-phenylbenzene were used instead of the additive of Comparative Example 1.

### Comparative Example 5: FCHB 2 wt %+FBP 5 wt %

An organic electrolyte was prepared in the same manner as in Comparative Example 1, except that 2 wt % of 1-fluoro-4-cyclohexylbenzene and 5 wt % of 1-fluoro-2-phenylbenzene were used instead of the additive of Comparative Example 1.

### Comparative Example 6: FCHB 3 wt %+FBP 6 wt %

An organic electrolyte was prepared in the same manner as in Comparative Example 1, except that 3 wt % of 1-fluoro-4-cyclohexylbenzene and 6 wt % of I-fluoro-2-phenylbenzene were used instead of the additive of Comparative Example 1.

### Comparative Example 7: CHB 0.5 wt %+FBP 3 wt %

An organic electrolyte was prepared in the same manner as in Comparative Example 1, except that 0.5 wt % of cyclohexylbenzene and 3 wt % of 1-fluoro-2-phenylbenzene were used instead of the additive of Comparative Example 1.

(Preparation of Lithium Battery)

### Example 5

(Preparation of Negative Electrode)

98 wt % of artificial graphite (BSG-L, manufactured by Tianjin BTR New Energy Technology Co., Ltd.), 1.0 wt % of styrene-butadiene rubber (SBR) binder (ZEON), and 1.0 wt % of carboxymethyl cellulose (CMC, manufactured by NIPPON A&L) were mixed, added to distilled water, and stirred for 60 minutes by using a mechanical stirrer to prepare a negative active material slurry. The slurry was applied to a thickness of about 60 μm on a copper current collector having a thickness of about 10 μm by using a doctor blade, dried for about 0.5 hours by using a hot-air dryer at a temperature of about 100° C., dried again in vacuum for about 4 hours at a temperature of about 120° C., and then, roll-pressed to prepare a negative electrode plate.

(Preparation of Positive Electrode)

97.45 wt % of LiNi_{1/3}Co_{1/3}Mn_{1/3}O₂, 0.5 wt % of artificial graphite (SFG6, Timcal) powder as a conducting agent, 0.7 wt % of carbon black (Ketjenblack, ECP), 0.25 wt % of modified acrylonitrile rubber (BM-720H, Zeon Corporation), 0.9 wt % of polyvinylidene fluoride (PVdF, S6020, Solvay), and 0.2 wt % of polyvinylidene fluoride (PVdF, S5130, Solvay) were mixed, added to N-methyl-2-pyrrolidone solvent, and then, stirred for about 30 minutes by using a mechanical stirrer to prepare a positive active material slurry. The slurry was applied to a thickness of about 60 μm on a copper current collector having a thickness of about 20 μm by using a doctor blade, dried for about 0.5 hours by using a hot-air dryer at a temperature of about 100° C., dried again in vacuum for about 4 hours at a temperature of about 120° C., and then, roll-pressed to prepare a positive electrode plate.

A ceramic-coated polyethylene separator having a thickness of about 14 μm was used as a separator, and the organic electrolyte of Example 1 was used as an electrolyte to manufacture a lithium battery.

### Examples 6 to 8

Lithium batteries were manufactured in the same manner as in Example 5, except that each of the organic electrolytes prepared in Examples 2 to 4 was used instead of the organic electrolyte of Example 1.

### Comparative Examples 8 to 14

Lithium batteries were manufactured in the same manner as in Example 5, except that each of the organic electrolytes prepared in Comparative Examples 1 to 7 was used instead of the organic electrolyte of Example 1.

### Evaluation Example 1: TCO 82 Overcharge Test

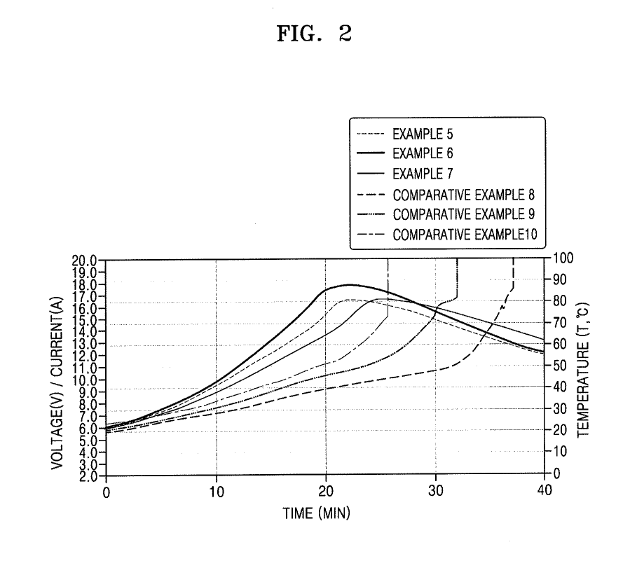

As the lithium batteries prepared in Examples 5 to 7 and Comparative Examples 8 to 10 were overcharged at the condition of 1 C and 18.5 V, time-dependent changes in resistance values and temperatures of the lithium batteries were measured. When the thermal cut-off was operated at a temperature close to 82° C., the corresponding lithium battery was determined to have passed the overcharge test and was marked with “O”. However, when the thermal cut-off was not operated, the corresponding lithium battery was determined to have failed the overcharge test and was marked with “X”. The results of the overcharge test are shown in Table 1 and FIG. 2.

TABLE 1

| | | Total amount | Overcharge |
|---|---|---|---|
| | Additive | (wt %) | test |
| Example 5 | FCHB 0.5 wt % + | 2.5 | ◯ |
| | FBP 2 wt % | | |
| Example 6 | FCHB 1 wt % + | 3 | ◯ |
| | FBP 2 wt % | | |
| Example 7 | FCHB 2 wt % + | 4 | ◯ |
| | FBP 2 wt % | | |
| Comparative Example 8 | FBP 2 wt % | 2 | X |
| Comparative Example 9 | FCHB 2 wt % | 2 | X |
| Comparative Example 10 | FCHB 1 wt % + | 2 | X |
| | FBP 1 wt % | | |

Referring to Table 1 and FIG. 2, the lithium batteries of Examples 5 to 7 including the organic electrolyte according to an example embodiment showed stability against overcharging at a high voltage.

### Evaluation Example 2: TCO 82 Overcharge Test

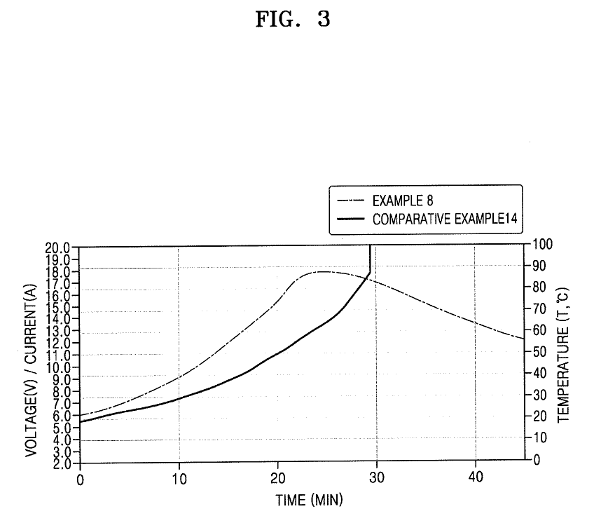

The overcharge test was performed on the lithium batteries prepared in Example 8 and Comparative Example 14 in the same manner as in Evaluation Example 1, except that the temperature for the thermal cut-off was exactly 82° C. The results of the overcharge test are shown in Table 2 and FIG. 3.

TABLE 2

| | | Total amount | Overcharge |
|---|---|---|---|
| | Additive | (wt %) | test |
| Example 8 | FCHB 0.5 wt % + | 3.5 | ◯ |
| | FBP 3 wt % | | |
| Comparative | CHB 0.5 wt % + FBP 3 wt % | 3.5 | X |
| Example 14 | | | |

In addition, referring to Table 2 and FIG. 3, the lithium battery of Example 8 including the organic electrolyte according to an example embodiment included FCHB, and showed stability against overcharging at a high voltage in contrast to the lithium battery of Comparative Example 14.

### Evaluation Example 3: Evaluation of Charging and Discharging Characteristics at High Temperature (60° C.) (Lifespan Evaluation)

The lithium batteries of Examples 5 to 7 and Comparative Examples 11 to 13 were charged at a temperature of 60° C. with a constant current at a rate of about 0.7 C until a voltage reached 4.35 V (vs. Li), and then cut-off at a current level at about a rate of about 0.05 C while maintaining a constant voltage of about 4.35 V. Then, the lithium batteries were discharged with a constant current at a rate of about 0.15 C until a voltage reached 3.0 V (vs. Li) (formation process, 1^{st} cycle).

The lithium batteries subjected to the first cycle of the formation process were charged at a temperature of 60° C. with a constant current at a rate of about 0.7 C until a voltage reached 4.35 V (vs. Li), and then, cut-off at a rate of about 0.05 C while maintaining a constant voltage at about 4.35 V. Then, the lithium batteries were discharged with a constant current at a rate of about 0.5 C until a voltage reached 3.0 V (vs. Li) (formation process, 2^{nd} cycle).

The lithium batteries subjected to the formation process were charged at a temperature of 60° C. with a constant current at a rate of about 1.0 C until a voltage reached 4.35 V (vs. Li). Then, a cycle in which the lithium batteries were discharged with a constant current at a rate of about 1 C until a voltage reached 3.0 V (vs. Li) was repeated until the 300^{th} cycle.

In all the charge and discharge cycles, a stopping time of 15 minutes was provided after one charge and discharge cycle.

Some of the results of the evaluation of charge and discharge characteristics are shown in Tables 3 and 4. A capacity retention rate at the 300^{th} cycle is defined by Equation 1 below:

Capacity retention rate=[Discharge capacity in the 300^{th} cycle/discharge capacity in the 1^{st} cycle]×100 <Equation 1>

TABLE 3

| | | | Discharge | |
|---|---|---|---|---|
| | | Total | capacity in the | Capacity retention |
| | | amount | 300^{th} cycle | rate in the 300^{th} cycle |
| | Additive | (wt %) | [mAh/g] | [%] |
| Example 5 | FCHB 0.5 wt % + FBP 2 wt % | 2.5 | 2467 | 55 |
| Example 6 | FCHB 1 wt % + FBP 2 wt % | 3 | 2229 | 50 |
| Example 7 | FCHB 1 wt % + FBP 3 wt % | 4 | 2166 | 48 |
| Comparative | FCHB 1 wt % + FBP 4 wt % | 5 | 650 | 14 |
| Example 11 | | | | |
| Comparative | FCHB 2 wt % + FBP 5 wt % | 7 | 22 | 1 |
| Example 12 | | | | |
| Comparative | FCHB 3 wt % + FBP 6 wt % | 9 | 0 | 0 |
| Example 13 | | | | |

Referring to Tables 3 and 4, the lithium batteries of Examples 5 to 7 including the organic electrolyte according to an example embodiment maintained the capacity of at least 2,150 mAh at the 300^{th} cycle and showed excellent lifespan characteristics at a high temperature. However, the lithium batteries of Comparative Examples 11 to 13 showed significantly degraded lifespan characteristics during charging and discharging at a high temperature.

By way of summation and review, lithium batteries operate at a high driving voltage, and thus, rather than an aqueous electrolyte, which is highly reactive to lithium, a non-aqueous electrolyte, e.g., an organic electrolyte, is used in lithium batteries. An organic electrolyte may be prepared by dissolving a lithium salt in an organic solvent. An organic solvent that is stable at a high voltage and has high ion conductivity and high dielectric constant and low viscosity may be used.

As lithium secondary batteries are made to have high capacity and high voltage, the stability of batteries is of importance. For example, when such high-capacity high-voltage batteries are continuously charged, degradation of the battery stability should be minimized. Generally, a small amount of an overcharge additive may be added to a non-aqueous electrolyte. However, when the overcharge additive has an oxidation decomposition potential of the overcharge additive that is lower than a charge potential, decomposition of the overcharge additive may occur as a charging/discharging cycle progresses. In addition, lifespan of a battery may be shortened as characteristics of the battery rapidly deteriorate at high temperatures. Accordingly, there is a need for a non-aqueous electrolyte containing an additive improving the stability against overcharging of a lithium battery (4.5 V system) without shortening lifespan of the high-voltage lithium battery at high temperatures.

As described above, embodiments may provide an organic electrolyte including an additive composition for a lithium battery electrolyte, and a lithium battery including the organic electrolyte may have improved stability against overcharging and improved lifespan characteristics at a high temperature.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. An additive composition for a lithium battery electrolyte, comprising a first compound represented by Formula 1 and a second compound represented by Formula 2: 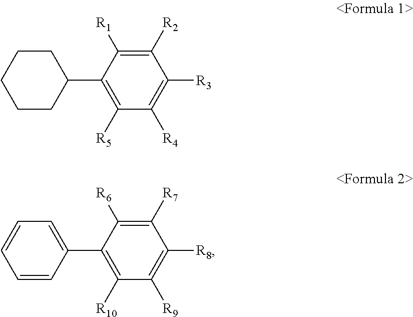
wherein, in Formulae 1 and 2,
R₁ to R₁₀ are each independently hydrogen; a halogen atom; a C₁-C₅ alkyl group; a C₁-C₅ alkyl group substituted with a halogen atom; a C₂-C₅ alkenyl group; a C₂-C₅ alkenyl group substituted with a halogen atom; a C₂-C₅ alkynyl group; a C₂-C₅ alkynyl group substituted with a halogen atom; a C₄-C₁₀ cycloalkyl group; a C₄-C₁₀ cycloalkyl group substituted with a halogen atom; a C₅-C₁₀ aryl group; or a C₅-C₁₀ aryl group substituted with a halogen atom, provided that at least one of R₁ to R₅ is a halogen atom, and at least one of R₆ to R₁₀ is a halogen atom, and
a composition ratio of the first compound to the second compound is in a range of about 1:2 to about 1:4 based on the total weight of the additive composition.

2. The additive composition as claimed in claim 1, wherein the composition ratio of the first compound to the second compound is in a range of about 1:2 to about 1:3 based on the total weight of the additive composition.

3. The additive composition as claimed in claim 1, wherein R₁ to R₁₀ in Formulae 1 and 2 are each independently hydrogen; a halogen atom; a methyl group; an ethyl group; a propyl group an isopropyl group; a butyl group; an isobutyl group; a tert-butyl group; or a pentyl group, provided that at least one of R₁ to R₅ is a halogen atom, and at least one of R₆ to R₁₀ is a halogen atom.

4. The additive composition as claimed in claim 1, wherein at least one of R₁ to R₅ in Formula 1 is fluorine, and at least one of R₆ to R₁₀ in Formula 2 is fluorine.

5. The additive composition as claimed in claim 1, wherein the first compound includes one or more of 1-fluoro-2-cyclohexylbenzene, 1-fluoro-3-cyclohexylbenzene, or 1-fluoro-4-cyclohexylbenzene, and the second compound includes one or more of 1-fluoro-2-phenylbenzene, 1-fluoro-3-phenylbenzene, or 1-fluoro-4-phenylbenzene.

6. The additive composition as claimed in claim 1, wherein the first compound and the second compound in the additive composition decompose at a voltage in a range of about 4.7 V to about 4.8 V.

7. An organic electrolyte comprising:
a lithium salt;
an organic solvent; and
the additive composition as claimed in claim 1.

8. The organic electrolyte as claimed in claim 7, wherein an amount of the additive composition is in a range of about 2.5 wt % to about 4 wt % based on the total weight of the organic electrolyte.

9. The organic electrolyte as claimed in claim 7, wherein an amount of the first compound is in a range of about 0.5 wt % to about 2 wt % based on the total weight of the organic electrolyte.

10. The organic electrolyte as claimed in claim 7, wherein an amount of the second compound is in a range of about 2 wt % to about 3.5 wt % based on the total weight of the organic electrolyte.

11. The organic electrolyte as claimed in claim 7, wherein:
a composition ratio of the first compound to the second compound in the additive composition is in a range of about 1:2 to about 1:4 based on the total weight of the additive composition, and
an amount of the additive composition is in a range of about 2.5 wt % to about 4 wt % based on the total weight of the organic electrolyte.

12. The organic electrolyte as claimed in claim 7, wherein the lithium salt includes one or more of LiPF₆, LiBF₄, LiSbF₆, LiAsF₆, LiClO₄, LiCF₃SO₃, Li(CF₃SO₂)₂N, LiC₄F₉SO₃, LiAlO₂, LiAlCl₄, LiN(CₓF₂ₓ₊₁SO₂)(C_{y}F_{2y+1}SO₂)(2≦x≦20, 2≦y≦20), LiCl, or LiI.

13. The organic electrolyte as claimed in claim 7, wherein a concentration of the lithium salt in the electrolyte is in a range of about 0.01 M to about 2.0 M.

14. The organic electrolyte as claimed in claim 7, wherein the organic solvent includes one or more of a diallylcarbonate, a cyclic carbonate, a linear or cyclic ester, a linear or cyclic amide, an aliphatic nitrile, or a linear or cyclic ether, or a derivative thereof.

15. A lithium battery comprising:
a positive electrode;
a negative electrode; and
the organic electrolyte as claimed in claim 7.

16. The lithium battery as claimed in claim 15, wherein the lithium battery has a voltage of at least 3.8 V.
